(19) United States
(12) Patent Application Publication
(10) Pub. No.: US 2003/0158045 A1
(43) Pub. Date: Aug. 21, 2003

(54) Lost circulation materials (LCM's) effective to maintain emulsion stability of drilling fluids

(76) Inventor: Michael Jarrett, Houston, TX (US)

Correspondence Address: Paula D Morris & Associates, PC, 2925 Briarpark Drive, Suite 930, Houston, TX, 77042-3728, US

(21) Appl. No.: 10/230,705

(22) Filed: Aug. 29, 2002

Related U.S. Application Data
(60) Provisional application No. 60/315,761, filed on Aug. 29, 2001.

(51) Int. Cl. C09K 7/00

(52) U.S. Cl. 507/100

(57) ABSTRACT

Lost circulation materials and methods for maintaining emulsion stability in emulsion type drilling, drill-in, and completion fluids, particularly invert emulsions.

The present application claims the benefit of U.S. Provisional Application Serial No. 60/315,761, filed Aug. 29, 2001, pending.

### FIELD OF THE INVENTION

The present invention relates to lost circulation materials, and to methods for maintaining emulsion stability in emulsion type drilling, drill-in, and completion fluids (hereinafter sometimes collectively referred to as “drilling fluids”) containing lost circulation material(s).

### BACKGROUND OF THE INVENTION

Drilling fluids serve various functions, such as promoting borehole stability, removing drilled cuttings from the wellbore, cooling and lubricating the bit and the drillstring, as well as controlling subsurface pressure. Certain subsurface conditions can cause, or lead to, “loss of circulation,” or the loss of whole drilling fluid in quantity to the formation. Examples of such subsurface conditions include, but are not necessarily limited to: (1) natural or intrinsic fractures, (2) induced or created fractures; (3) cavernous formations (crevices and channels), and (4) unconsolidated or highly permeable formations (loose gravels).

Lost circulation materials are used to minimize loss of circulation. The lost circulation material forms a filter cake that effectively blocks voids in the formation. Currently, lost circulation materials include fibrous materials, such as cedar bark and shredded cane stalk, flaky materials such as mica flakes, and granular materials such as ground limestone, wood, nut hulls, corncobs, and cotton hulls.

Unfortunately, low electrical stability values have been reported for invert emulsion drilling fluids containing fibrous cellulosic lost circulation material. If the electrical stability value of a drilling fluid becomes too low, water wetting of solids occurs, which may cause the rheological properties of the fluid to break down, rendering the drilling fluid ineffective and even resulting in a shutdown of drilling operations.

Lost circulation materials and methods of use are needed which maintain electrical stability, and thereby emulsion stability of drilling fluids.

### SUMMARY OF THE INVENTION

The invention provides a method for maintaining electrical stability in a drilling, drill-in, or completion fluid comprising lost circulation material (LCM), said method comprising:

providing an initial fluid selected from the group consisting of a drilling, drill-in, or completion fluid, said initial fluid having effective rheology and fluid loss control properties;

adding to said initial fluid a fibrous LCM consisting essentially of a quantity of high lignin lost circulation material (HLLCM), thereby producing a treated fluid.

In another aspect, the invention provides a method for maintaining electrical stability in a drilling, drill-in, or completion fluid, said method comprising:

providing an initial fluid selected from the group consisting of a drilling, drill-in, or completion fluid having effective rheology and fluid loss control properties; and

using as LCM in said initial fluid a fibrous HLLCM having a water retention value of about 1 or less.

In yet another aspect, the invention provides a method for maintaining electrical stability in a drilling, drill-in, or completion fluid, said method comprising:

providing an initial fluid selected from the group consisting of a drilling, drill-in, or completion fluid, said initial fluid having effective rheology and fluid loss control properties; and

using grape pumice as a lost circulation material.

In preferred embodiments, said initial fluid exhibits a first electrical stability value and said treated fluid exhibits a second electrical stability value that is a maximum of 18% less than said first electrical stability value; more preferably 15% less than said first electrical stability value; most preferably 12% less than said first electrical stability value. The initial fluid preferably is an emulsion base fluid, most preferably an invert emulsion fluid. The fibrous HLLCM preferably has a water retention value of about 1 or less, more preferably about 0.5 or less, even more preferably about 0.3 or less. Preferred HLLCM's are selected from the group consisting of grape pumice, bulrush plants, and lignin byproducts from processing plant material into paper. A most preferred HLLCM is grape pumice. The HLLCM preferably comprises a particle size distribution of from about 10 μm to about 200 μm.

In another aspect, the invention provides a fluid selected from the group consisting of a drilling, drill-in, or completion fluid having effective rheology and fluid loss control properties and comprising a lost circulation material consisting essentially of an HLLCM.

In another aspect, the invention provides a fluid selected from the group consisting of a drilling, drill-in, or completion fluid, said fluid having effective rheology and fluid loss control properties and consisting essentially of an LCM having a water retention value of about 1 or less.

In another aspect, the invention provides a fluid selected from the group consisting of a drilling, drill-in, or completion fluid, said fluid having effective rheology and fluid loss control properties and comprising a fibrous LCM, said fibrous LCM consisting essentially of materials selected from the group consisting of grape pumice, bulrush plants, and lignin byproducts from the processing of plant material into paper.

In yet another aspect, the invention provides a fluid selected from the group consisting of a drilling, drill-in, or completion fluid, said fluid having effective rheology and fluid loss control properties and comprising a fibrous LCM consisting essentially of grape pumice.

In preferred embodiments, the initial fluid exhibits a first electrical stability value and a fluid comprising said HLLCM exhibits a second electrical stability value that is a maximum of 18% less than said first electrical stability value; more preferably 15% less than said first electrical stability value; most preferably 12% less than said first electrical stability value. The initial fluid preferably is an emulsion base fluid, most preferably an invert emulsion fluid. The fibrous HLLCM preferably has a water retention value of about 1 or less, more preferably about 0.5 or less, even more preferably about 0.3 or less. Preferred HLLCM's are selected from the group consisting of grape pumice, bulrush plants, and lignin byproducts from processing plant material into paper. A most preferred HLLCM is grape pumice. The HLLCM preferably comprises a particle size distribution of from about 10 μm to about 200 μm.

In yet another aspect, the invention provides a spotting pill comprising from about 1 to about 100 ppb of an HLLCM and a carrier liquid. Preferably, the spotting pill comprises from about 5 to about 50 ppb of an HLLCM and a carrier liquid.

The HLLCM preferably consists essentially of materials selected from the group consisting of grape pumice, bulrush plants, and lignin byproducts from the processing of plant material into paper. In a most preferred embodiment, the HLLCM is grape pumice.

In yet another aspect, the invention provides a spotting pill comprising from about 1 to about 100 ppb grape pumice a carrier liquid, preferably from about 5 to about 50 ppb of grape pumice and a carrier liquid.

The carrier liquid preferably is selected from the group consisting of a polyalkylene oxides and copolymers thereof, polyalkyleneoxide glycol ethers, glycols, polyglycols, tripropylene glycol bottoms, and combinations thereof. In a preferred embodiment, the carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers. In another preferred embodiment, the carrier liquid is selected from the group consisting of ethylene glycol, tripropylene glycol bottoms, and combinations thereof.

In a most preferred embodiment, the carrier liquid comprises tripropylene glycol bottoms. In a most preferred embodiment, the HLLCM is grape pumice, most preferably combined with tripropylene glycol bottoms. Where alkalinity of the drilling fluid is a concern, the pH may be maintained by using about 0.2 lb soda ash to about 1 lb grape pumice, in the spotting additive, or during mixing.

### BRIEF DESCRIPTION OF THE DRAWINGS

FIG. 1 is a graph showing comparative LCM effects upon electrical stability in a field ECO-FLOW sample.

FIG. 2 is a graph showing a particle size distribution analyses of CHECK-LOSS® in various fluids.

### DETAILED DESCRIPTION OF THE INVENTION

Measurements of an emulsion-type drilling fluid are continually made in an effort to identify any loss in emulsion stability resulting from loss of circulation of the drilling fluid. A preferred method of measuring emulsion stability in invert emulsion drilling fluids is to measure the electrical stability of the drilling fluid.

The electrical stability of an oil-based drilling fluid relates both to its emulsion stability and to its oil-wetting capability. Electrical stability of a drilling fluid is determined by applying a voltage-ramped, sinusoidal electrical signal across a pair of parallel flat-plate electrodes immersed in the drilling fluid. The resulting current remains low until a threshold voltage is reached, whereupon the current rises very rapidly. This threshold voltage is the electrical stability of the drilling fluid and is defined as the voltage in peak volts-measured when the current reaches 61 μA.

Field operators monitor the emulsion stability of a drilling fluid by reading the voltage across the drilling fluid. The resulting electrical stability reading is directly related to the ratio of water to oil in a particular drilling fluid. As the concentration of water in the drilling fluid increases, the electrical stability value tends to decrease.

The reported decrease in electrical stability values in invert emulsion drilling fluids appears to be attributable to swollen, hydrated fibers of lost circulation material that come into contact with the electrical stability meter probe. In order to preserve electrical stability (and thereby emulsion stability), water wetting of such fibrous materials must be minimized.

The type of lost circulation material added to a particular drilling fluid varies according to the primary purpose of the drilling operation; the nature of the rocks to be penetrated; the site, and the skill and experience of the drilling crew. Various plant source fibers are used as lost circulation materials. Cellulose is a major constituent of most plant cell walls, and also has a high affinity for water. Without limiting the invention to a particular mechanism of action, the decrease in electrical stability of drilling fluids comprising many fibrous lost circulation materials is believed to be due to the intrinsic affinity of the cellulose in those fibers for water. In order to reduce the impact of a lost circulation material on electrical stability readings, the present invention reduces the cellulosic content of the fibrous material.

Lignin also is found in plant cell walls. Lignin is a strengthening polymer which provides rigidity and strength to the plant material. Lignin does not have as great an affinity for water as cellulose. Plant materials with higher lignin contents should have a directly or indirectly proportional decrease in affinity for water. It is difficult to analyze plant materials directly to determine their lignin content.

The present invention involves the use of “high lignin” lost circulation materials (HLLCM's) in drilling fluids. HLLCM's increase electrical stability values in emulsion type fluids, and thereby increase emulsion stability. “HLLCM's” are herein defined as fibrous lost circulation materials effective to maintain the electrical stability value of a given drilling, drill-in or completion fluid to within 20% or less of the electrical stability value of the same fluid in the absence of the HLLCM. Preferred HLLCM's are effective to maintain the electrical stability value of a given drilling, drill-in or completion fluid within 18% of the electrical stability value of the same fluid in the absence of the HLLCM, more preferably to within about 15%, and most preferably to within about 12%. Another way of stating the electrical stability limitation is that the addition of the HLLCM causes a maximum reduction in voltage reading of 20% or less relative to the initial voltage reading, more preferably about 18% or less, even more preferably about 15 % or less, most preferably about 12% or less.

Suitable HLLCM's may be identified with reference to their “Water Retention Value” (WRV). A given plant material has a given hydration rate based on the size of voids within the fibers of that plant material. When the dry plant material is exposed to water, these voids are swollen by the water. The swelling of these voids in the presence of water may be measured, and the measured value is known as the material's WRV. The WRV is a measure of the amount of water intimately associated with a given dry weight of a given plant material, and is approximately equal to the total change in volume of the cell wall of the plant material.

The WRV for a given plant material may be calculated upon performing a simple test. Add 25 g test material to a glass jar. Mix 250 ml of deionized water with the test material. Shear the slurry at 3000 rpm for 5 min. Cap the glass jar roll 16 hr at 150° F. After cooling, pour the jar contents into an assembled Buchner funnel (using Whatman filter paper No. 41) fitted on a 2-liter Erlenmeyer flask, hooked to a vacuum pump. Filter for two hours maximum. Remove the Buchner funnel with test material from the flask and weigh. Calculate the WRV using the following equation:

(Buchner funnel with filter (Buchner funnel with wet paper)−paper and retained wet test material)/Initial 25 g dry test material.

Fibrous lost circulation materials in current use have a calculated WRV of about 4 or more. HLLCM's that are suitable for use in the present invention have a calculated WRV of 1 or less, preferably 0.5 or less, and more preferably 0.3 or less.

Examples of suitable HLLCM's include, but are not necessarily limited to plants that actually grow in water but tend to remain dry, such as bulrush plants, which include cattails, papyrus, and the like. Also suitable are lignin byproducts derived from the processing of wood or other plant materials into paper. The products made from such processes typically require high contents of cellulose, and lignin is processed out of the wood. The lignin typically is sold for sulfonation.

The HLLCM generally has a particle size distribution effective to form a filter cake and to block loss of circulation of the drilling fluid to the formation. Suitable particle size distributions generally are from about 10 μm to about 200 μm, preferably from about 15 to about 170.

A most preferred HLLCM for use in the invention is grape pumice. HLLCMs, preferably grape pumice, have the added advantage of inducing less impact upon rheological properties.

The HLLCM preferably is used in emulsion type drilling fluids, most preferably invert emulsion drilling fluids. However, HLLCM's are useful as a lost circulation materials in any type of drilling fluid, including water base fluids, natural or synthetic oil base fluids, oil-in-water emulsion fluids, and water-in-oil emulsion fluids.

The HLLCM may be included as an integral part of a drilling fluid, and/or added to a drilling fluid, as needed, during drilling operations. Where the HLLCM is used as an integral part of a drilling fluid, the quantity used is from about 0.1 ppg to about 25 ppg, preferably from about 5 ppg to about 10 ppg. Where the HLLCM is added to the drilling fluid as needed during operation, the HLLCM is simply added to the mud pit with mixing, as needed. The quantity of HLLCM added will vary depending upon the extent of the loss in circulation. Typically, the quantity is from about 0.1 ppg to about 25 ppg or more.

Alternately, the HLLCM is added to the mud pit as a spotting pill. In this embodiment, the HLLCM is added as a slurry, together with a small amount of a carrier liquid that is compatible with the fluid being treated. A preferred slurry comprises from about 1 ppb to about 100 ppb HLLCM, preferably about 5 to about 50 ppb HLLCM. A most preferred spotting pill is from about 1 ppb to about 100 ppb grape pumice in a carrier fluid, preferably from about 5 to about 50 ppb grape pumice. Typically, after the HLLCM is spotted opposite the loss zone, it is desirable to pull into the casing and wait six to eight hours before continuing operations.

Whether used as a integral part of the drilling fluid, or in a spotting pill, certain HLLCM's, such as grape pumice, tend to increase the acidity of water base fluids. Hence, where the HLLCM is used in a water base fluid, it is preferred to add a sufficient quantity of a buffering agent to increase the pH to neutral, or about 7. Suitable buffering agents include but are not necessarily limited to soda ash, sodium bicarbonate, sodium hydroxide, lime, calcium hydroxide, and the like. A suitable amount of buffering agent is from about 0.1 lb to about 0.2 lb, preferably 0.1 lb, for every 10 lbs. HLLCM, preferably grape pumice.

Suitable carrier fluids for a spotting pill vary depending upon the fluid being treated. Where the fluid is a water base fluid, the carrier preferably will be aqueous. Where the fluid is an oil base fluid, the carrier preferably will be non-aqueous, and so forth. In a preferred embodiment, the carrier fluid is selected from the group consisting of glycols, polyglycols, polyalkyleneoxides, alkyleneoxide copolymers, alkylene glycol ethers, polyalkyleneoxide glycol ethers, and salts of any of the foregoing compounds, and combinations of the foregoing compounds.

Examples of suitable glycols and polyglycols include, but are not necessarily limited to ethylene glycols, diethylene glycols, triethylene glycols, tetraethylene glycols, propylene glycols, dipropylene glycols, tripropylene glycols, and tetrapropylene glycols. Examples of suitable polyalkyleneoxides and copolymers thereof include, but are not necessarily limited to polyethylene oxides, polypropylene oxides, and copolymers of polyethylene oxides and polypropylene oxides. Suitable polyalkyleneoxide glycol ethers include, but are not necessarily limited to polyethylene glycol ethers, polypropylene glycol ethers, polyethylene oxide glycol ethers, polypropylene oxide glycol ethers, and polyethylene oxide/polypropylene oxide glycol ethers. Preferred carriers are ethylene glycol, tripropylene glycol bottoms, and combinations thereof. A most preferred carrier is tripropylene glycol bottoms.

The invention will be better understood with reference to the following Examples, which are illustrative only. In the examples, CHEK-LOSS® is a corn cob based LCM, available from Baker Hughes INTEQ; PHENO-SEAL® is a ground plastic resin material, available from Montello, Inc.; MUD-LINER is a paper based LCM, available from BCI Incorporated; LIQUID CASING is a peanut hull based LCM available from Liquid Casing, Incorporated; KWIK SEAL FINE is a blend of vegetable and polymer fibers available from Kelco Oilfield Group; and BAROFIBRE is an almond hull based LCM, available from Baroid/Halliburton.

### EXAMPLE 1

Field operations personnel reported continuing problems of low electrical stability values for invert emulsion drilling fluids containing fibrous lost circulation material (LCM) additives. Although not identifying the specific additives, a report indicated that all fibrous materials lowered electrical stability values. However, HPHT fluid losses of the laboratory test muds showed no evidence of water. The criteria of absence of water in the HPHT filtrate was used as the preferred method of determining emulsion stability.

The following is an assessment of the effects of various LCM additives on electrical stability, Theological properties, and HPHT/PPA filtration control of synthetic-based fluids.

Equipment

1. Prince Castle mixer

2. Fann viscometer, Model 35A

3. Thermometer, dial, 0-220° F.

4. Balance with precision of 0.01 g

5. Sieves (conforming to ASTM E11 requirements)

6. Roller oven, 150-250±5° F. (66-121±3° C.)

7. Static aging oven

8. Wash bottle

9. Retsch grinding mill

10. Mortar and pestle

11. Spatula

12. Timer: interval, mechanical or electrical, precision of 0.1 minute

13. Jars (approximately 500 ml capacity) with sealing lids

14. Heating cup, OFI, 115 volt

16. Malvern Mastersizer

Procedures

The following INTEQ Fluids Laboratory procedures were used:

Recommended Practice Standard Procedure for Field Testing Oil-Based Drilling Fluids, API Recommended Practice 13B-2, Third Edition, February 1998

Recommended Practice Standard Procedure for Field Testing Water-Based Drilling Fluids, API Recommended Practice 13B-1, Second Edition, September 1997

Instrumentation Manual for Malvern Mastersizer

The following were the results

TABLE 1
Comparative evaluation of CHEK-LOSS ® and BLEN-PLUG OM in field SYN-TEQ ® samples

| Materials | | | | | | | |
|---|---|---|---|---|---|---|---|
| SYN-TEQ (unknown LCM) Sample A, bbl | 1.0 | 1.0 | 1.0 | 1.0 | — | — | — |
| SYN-TEQ Sample B, bbl | — | — | — | — | 1.0 | 1.0 | 1.0 |
| CHEK-LOSS, Sample C, lb/bbl | — | 10 | — | — | — | 10 | — |
| BLEN-PLUG OM, Sample D, lb/bbl | — | — | 10 | — | — | — | 10 |
| Stirred 15 min | 1290 | 1160 | 1040 | 1290 | 220 | 175 | 160 |
| Electrical stability, volt | | | | | | | |
| Rolled 16 hr, 150° F. | | | | | | | |
| FANN 35 Properties: | | | | | | | |
| 600 rpm rdg, 120° F. | 145 | 233 | n/m | 145 | 54 | 70 | n/m |
| 300 rpm rdg | 82 | 131 | — | 82 | 30 | 39 | — |
| 200 rpm rdg | 61 | 95 | — | 61 | 21 | 28 | — |
| 100 rpm rdg | 38 | 58 | — | 38 | 13 | 17 | — |
| 6 rpm rdg | 10 | 14 | — | 10 | 3 | 4 | — |
| 3 rpm rdg | 8 | 11 | — | 8 | 2 | 3 | — |
| Plastic viscosity, cp | 63 | 102 | — | 63 | 24 | 31 | — |
| Yield point, lb/100 ft² | 19 | 29 | — | 19 | 6 | 8 | — |
| 10-sec gel, lb/100 ft² | 10 | 12 | — | 10 | 3 | 5 | — |
| 10-min gel, lb/100 ft² | 13 | 16 | — | 13 | 5 | 7 | — |
| Electrical stability, volt | 1150 | 350 | 330 | 1150 | 220 | 150 | 130 |
| 60-mesh screened | | ✓ | ✓ | | | | |
| Electrical stability, volt | — | 390 | 350 | — | | | |
| Treatment: | | | | | | | |
| Baroid DrilTreat, lb/bbl | 5.0 | 5.0 | 5.0 | — | | | |
| INTOIL-S, lb/bbl | — | — | — | 5.0 | | | |
| Electrical stability, volt | 1290 | 385 | 350 | 1290 | | | |
| CHEK-LOSS, lb | 10 | — | — | 10 | | | |
| Rolled 16 hr, 150° F. | | | | | | | |
| Electrical stability, volt | 430 | | | 440 | | | |
| 600 rpm rdg, 120° F. | 205 | | | 222 | | | |
| 300 rpm rdg | 118 | | | 129 | | | |
| 200 rpm rdg | 87 | | | 95 | | | |
| 100 rpm rdg | 54 | | | 60 | | | |
| 6 rpm rdg | 14 | | | 15 | | | |
| 3 rpm rdg | 11 | | | 12 | | | |
| Plastic viscosity, cp | 87 | | | 93 | | | |
| Yield point, lb/100 ft² | 31 | | | 36 | | | |
| 10-sec gel, lb/100 ft² | 15 | | | 16 | | | |
| 10-min gel, lb/100 ft² | 18 | | | 19 | | | |

TABLE 2
Comparative evaluation of a) wetting agents with CHEK-LOSS ® in a field ECO-FLOW
and b) competitive fibrous LCM additives versus MIL-CARB ® or PHENO-SEAL

| | A: Wetting Agents with CHEK-LOSS | | | | | | B: Fibrous LCM versus MIL-CARB | | | | | | |
|---|---|---|---|---|---|---|---|---|---|---|---|---|---|
| Materials | | | | | | | | | | | | | |
| ECO-FLOW, | 1.0 | 1.0 | 1.0 | 1.0 | 1.0 | 1.0 | 1.0 | 1.0 | 1.0 | 1.0 | 1.0 | 1.0 | 1.0 |
| Sample E, bbl | | | | | | | | | | | | | |
| DRILTREAT, | — | — | 5.0 | — | — | — | — | — | — | — | — | — | — |
| lb/bbl | | | | | | | | | | | | | |
| INTOIL-S, | — | — | — | 5.0 | — | — | — | — | — | — | — | — | — |
| lb/bbl | | | | | | | | | | | | | |
| BIO-COTE ™, | — | — | — | — | 2.5 | — | — | — | — | — | — | — | — |
| lb/bbl | | | | | | | | | | | | | |
| OMNI- | — | — | — | — | — | 2.5 | — | — | — | — | — | — | — |
| COTE ®, | | | | | | | | | | | | | |
| lb/bbl | | | | | | | | | | | | | |
| CHEK-LOSS, | — | 10 | 10 | 10 | 10 | 10 | — | — | — | — | — | — | — |
| lb/bbl | | | | | | | | | | | | | |
| PHENO- | — | — | — | — | — | — | 10 | — | — | — | — | — | — |
| SEAL, lb/bbl | | | | | | | | | | | | | |
| LUBRA- | — | — | — | — | — | — | — | 10 | — | — | — | — | — |
| SEAL, lb/bbl | | | | | | | | | | | | | |
| BAROFIBRE, | — | — | — | — | — | — | — | — | 10 | — | — | — | — |
| lb/bbl | | | | | | | | | | | | | |
| MUD LINER, | — | — | — | — | — | — | — | — | — | 10 | — | — | — |
| lb/bbl | | | | | | | | | | | | | |
| LIQUID | — | — | — | — | — | — | — | — | — | — | 10 | — | — |
| CASING, | | | | | | | | | | | | | |
| lb/bbl | | | | | | | | | | | | | |
| ULTRASEAL, lb/bbl | — | — | — | — | — | — | — | — | — | — | — | 10 | — |
| MIL-CARB, | — | — | — | — | — | — | — | — | — | — | — | — | 10 |
| lb/bbl | | | | | | | | | | | | | |
| Stirred 15 min | | | | | | | | | | | | | |
| Rolled 16 hr, | | | | | | | | | | | | | |
| 150° F. | | | | | | | | | | | | | |

Properties

| | | | | | | | | | | | | | |
|---|---|---|---|---|---|---|---|---|---|---|---|---|---|
| 600 rpm rdg, | 122 | 178 | 155 | 168 | 153 | 150 | 125 | 136 | 157 | 198 | 165 | 160 | 124 |
| 120° F. | | | | | | | | | | | | | |
| 300 rpm rdg | 72 | 100 | 88 | 95 | 80 | 80 | 73 | 79 | 90 | 112 | 94 | 90 | 73 |
| 200 rpm rdg | 52 | 73 | 66 | 70 | 54 | 57 | 54 | 59 | 65 | 81 | 68 | 67 | 54 |
| 100 rpm rdg | 33 | 45 | 41 | 43 | 30 | 33 | 34 | 36 | 41 | 49 | 42 | 45 | 33 |
| 6 rpm rdg | 10 | 12 | 11 | 12 | 4 | 4 | 10 | 10 | 11 | 12 | 11 | 13 | 10 |
| 3 rpm rdg | 8 | 10 | 9 | 10 | 3 | 3 | 8 | 8 | 10 | 11 | 10 | 12 | 8 |
| Plastic | 50 | 78 | 67 | 73 | 73 | 70 | 52 | 57 | 67 | 86 | 71 | 70 | 51 |
| viscosity, cp | | | | | | | | | | | | | |
| Yield point, | 22 | 22 | 21 | 22 | 7 | 10 | 21 | 22 | 23 | 26 | 23 | 20 | 22 |
| lb/100 ft² | | | | | | | | | | | | | |
| 10-sec gel, | 11 | 12 | 12 | 12 | 4 | 4 | 11 | 11 | 12 | 13 | 12 | 12 | 11 |
| lb/100 ft² | | | | | | | | | | | | | |
| 10-min gel, | 14 | 15 | 15 | 16 | 6 | 9 | 14 | 15 | 14 | 16 | 15 | 15 | 14 |
| lb/100 ft² | | | | | | | | | | | | | |
| Electrical | 1170 | 620 | 640 | 500 | 440 | 480 | 1170 | 720 | 850 | 500 | 650 | 750 | 1160 |
| stability, volt | | | | | | | | | | | | | |
| HPHT | 10.8 | 11.2 | — | — | — | — | 10.0 | 10.6 | 11.6 | 10.8 | 10.2 | 10.8 | 10.0 |
| (250° F.), ml | | | | | | | | | | | | | |
| Water in | no | no | — | — | — | — | no | no | no | no | no | no | no |
| filtrate | | | | | | | | | | | | | |

TABLE 3
Effect of CHEK-LOSS ® on electrical stability and particle size

| Materials | | | | | | | | | | | | |
|---|---|---|---|---|---|---|---|---|---|---|---|---|
| ISO-TEQ ®, | — | — | 0.75 | 0.75 | 0.85 | 0.85 | 0.95 | 0.95 | 1.00 | 1.00 | 1.00 | 1.00 |
| bbl | | | | | | | | | | | | |
| OMNI- | — | — | 12 | 12 | 12 | 12 | 12 | 12 | 12 | 12 | — | — |
| MUL ®, lb/bbl | | | | | | | | | | | | |
| Deionized | 1.00 | 1.00 | 0.25 | 0.25 | 0.15 | 0.15 | 005 | 0.05 | — | — | — | — |
| Water, bbl | | | | | | | | | | | | |
| CHEK- | — | 50 | — | 50 | — | 50 | — | 50 | — | 50 | — | 50 |
| LOSS ®, lb/bbl | | | | | | | | | | | | |
| Stirred 30 min | | | | | | | | | | | | |
| Rolled 16 hr, | | | | | | | | | | | | |
| 150° F. | | | | | | | | | | | | |
| Properties | | | | | | | | | | | | |
| Electrical | <5 | <5 | 150 | 10 | 230 | 15 | 1100 | 95 | 2000 | 2000 | 2000 | 2000 |
| stability, volt | | | | | | | | | | | | |
| Particle Size | | | | | | | | | | | | |
| Analyses | | | | | | | | | | | | |
| by Malvern | | | | | | | | | | | | |
| D (v, 0.1) | — | 17.9 | — | 23.6 | — | 36.8 | — | 16.4 | — | 17.9 | — | 15.1 |
| D (v, 0.5) | — | 64.5 | — | 84.3 | — | 95.2 | — | 70.3 | — | 60.7 | — | 65.6 |
| D (v, 0.9) | — | 142 | — | 204 | — | 203 | — | 169 | — | 137 | — | 175 |

TABLE 4
Evaluation of Other fibrous LCM additives as compared to CHEK-LOSS ®

| | | | | | | | |
|---|---|---|---|---|---|---|---|
| Materials | | | | | | | |
| UNOCAL ECO- | 1.0 | 1.0 | 1.0 | 1.0 | 1.0 | 1.0 | 1.0 |
| FLOW | | | | | | | |
| Field Sample (FSR 4341d), bbl | | | | | | | |
| CHEK-LOSS, lb/bbl | — | 10 | — | — | — | — | — |
| Slurry Blend*, lb/bbl | — | — | 12.5 | — | — | — | — |
| LCM Blend**, lb/bbl | — | — | — | 10 | — | — | — |
| KWIK-SEAL Fine, | — | — | — | — | 10 | — | — |
| lb/bbl | | | | | | | |
| MASTERSEAL, lb/bbl | — | — | — | — | — | 10 | — |
| LCP***, lb/bbl | — | — | — | — | — | — | 10 |
| Stirred 30 min | | | | | | | |
| Rolled 16 hr, 150° F. | | | | | | | |

Properties

| | | | | | | | |
|---|---|---|---|---|---|---|---|
| Electrical stability, volt | 1470 | 700 | 740 | 880 | 1280 | 1300 | 970 |
| 600 rpm rdg, 120° F. | 126 | 175 | 128 | 166 | 134 | 137 | 150 |
| 300 rpm rdg | 72 | 100 | 70 | 95 | 77 | 77 | 85 |
| 200 rpm rdg | 53 | 78 | 50 | 70 | 58 | 57 | 60 |
| 100 rpm rdg | 32 | 49 | 31 | 42 | 37 | 36 | 37 |
| 6 rpm rdg | 8 | 12 | 8 | 11 | 10 | 10 | 10 |
| 3 rpm rdg | 7 | 10 | 7 | 10 | 8 | 8 | 8 |
| Plastic viscosity, cp | 54 | 75 | 58 | 71 | 57 | 60 | 65 |
| Yield point, lb/100 ft² | 18 | 25 | 12 | 24 | 20 | 17 | 20 |
| 10-sec gel, lb/100 ft² | 10 | 11 | 9 | 13 | 12 | 11 | 12 |
| 10-min gel, lb/100 ft² | 13 | 15 | 11 | 15 | 14 | 14 | 14 |
| HPHT (250° F.), cm³/30 min | 2.0 | 2.4 | — | — | 2.4 | 2.0 | — |
| Water in Filtrate? | no | no | — | — | no | no | — |

Notes:
*Slurry blend prepared by mixing 0.86 bbl ISO-TEQ ®, 12 lb/bbl OMNI-COTE ® and 125 lb/bbl CHEK-LOSS ®; added 12 lb/bbl of slurry (equivalent to 10 lb/bbl CHEK-LOSS) to base mud.
**LCM blend prepared by mixing 60% by weight MIL-GRAPHITE, 35% CHEK-LOSS ®, 2.5% WITCO 90 FLAKE and 2.5% INDUSTRENE R FLAKE.
***LCP supplied by Environmental Drilling Technology (Tulsa, OK).

TABLE 5
Performance of KWIK-SEAL Fine compared
to CHEK-LOSS ® Coarse

Materials:

| | | | | | |
|---|---|---|---|---|---|
| UNOCAL ECO-FLOW | 1.0 | 1.0 | 1.0 | 1.0 | 1.0 |
| Field Sample | | | | | |
| (FSR 4341d), bbl | | | | | |
| CHEK-LOSS ® Coarse, | — | 10 | — | — | — |
| lb/bbl | | | | | |
| CHEK-LOSS ® Coarse | — | — | 10 | — | — |
| Retsch ground*, | | | | | |
| lb/bbl | | | | | |
| KWIK-SEAL Fine, | — | — | — | 10 | — |
| lb/bbl | | | | | |
| KWIK-SEAL Fine | — | — | — | — | 10 |
| Retsch ground*, | | | | | |
| lb/bbl | | | | | |
| Stirred 30 min | | | | | |
| Rolled 16 hr, | | | | | |
| 150° F. | | | | | |

Properties:

| | | | | | |
|---|---|---|---|---|---|
| Electrical | 1470 | 900 | 580 | 1280 | 1100 |
| stability, volt | | | | | |
| 600 rpm rdg, | 126 | 150 | 160 | 134 | 145 |
| 120° F. | | | | | |
| 300 rpm rdg | 72 | 85 | 90 | 77 | 83 |
| 200 rpm rdg | 53 | 63 | 67 | 58 | 61 |
| 100 rpm rdg | 32 | 38 | 41 | 37 | 37 |
| 6 rpm rdg | 8 | 12 | 12 | 10 | 11 |
| 3 rpm rdg | 7 | 11 | 11 | 8 | 10 |
| Plastic viscosity, | 54 | 65 | 70 | 57 | 62 |
| cp | | | | | |
| Yield point, | 18 | 20 | 20 | 20 | 21 |
| lb/100 ft² | | | | | |
| 10-sec gel, | 10 | 12 | 12 | 12 | 12 |
| lb/100 ft² | | | | | |
| 10-min gel, | 12 | 14 | 16 | 14 | 14 |
| lb/100 ft² | | | | | |
| Particle Size | | | | | |
| Analyses of | | | | | |
| Ground LCM additives | | | | | |
| by Malvern: | | | | | |
| D (v, 0.1) | | | 12.96 | | 15.11 |
| D (v, 0.5) | | | 100.9 | | 99.4 |
| D (v, 0.9) | | | 335.8 | | 369 |

Notes:
*LCM additives ground by Retsch apparatus

TABLE 6
PPA STUDY - Evaluation of KWIK-SEAL ® Fine
compared to CHEK-LOSS ® Coarse in a laboratory
prepared 12 lb/gal SYN-TEQ ® fluid

| | | | | | | |
|---|---|---|---|---|---|---|
| Materials | | | | | | |
| Lab-Prepared Base | 1.0 | 1.0 | 1.0 | 1.0 | 1.0 | 1.0 |
| Mud*, bbl | | | | | | |
| CHEK-LOSS ®, lb/bbl | — | 10 | — | — | — | — |
| CHEK-LOSS ® Coarse, | — | | 10 | | | |
| lb/bbl | | | | | | |
| CHEK-LOSS ® Coarse | — | — | — | 10 | — | — |
| Retsch ground**, | | | | | | |
| lb/bbl | | | | | | |
| KWIK-SEAL ® Fine, | — | — | — | — | 10 | — |
| lb/bbl | | | | | | |
| KWIK-SEAL ® Fine | — | — | — | — | — | 10 |
| Retsch ground**, | | | | | | |
| lb/bbl | | | | | | |
| Stirred 30 min | | | | | | |
| Rolled 16 hr, | | | | | | |
| 150° F. | | | | | | |

Properties

| | | | | | | |
|---|---|---|---|---|---|---|
| Electrical | 1000 | 440 | 600 | 475 | 750 | 700 |
| stability, volt | | | | | | |
| 600 rpm rdg, | 113 | 120 | 114 | 118 | 94 | 112 |
| 120° F. | | | | | | |
| 300 rpm rdg | 73 | 75 | 76 | 75 | 60 | 70 |
| 200 rpm rdg | 58 | 59 | 60 | 59 | 45 | 53 |
| 100 rpm rdg | 40 | 42 | 43 | 43 | 32 | 36 |
| 6 rpm rdg | 17 | 17 | 17 | 17 | 14 | 15 |
| 3 rpm rdg | 15 | 15 | 15 | 15 | 12 | 13 |
| Plastic | 40 | 45 | 38 | 43 | 34 | 42 |
| viscosity, cp | | | | | | |
| Yield point, | 33 | 30 | 38 | 32 | 26 | 28 |
| lb/100 ft² | | | | | | |
| 10-sec gel, | 17 | 17 | 17 | 17 | 14 | 15 |
| lb/100 ft² | | | | | | |
| 10-min gel, | 19 | 19 | 19 | 19 | 16 | 18 |
| lb/100 ft² | | | | | | |
| PPA (90-micron, | | | | | | |
| 250° F.) | | | | | | |
| Initial spurt | 4.2 | 3.0 | 3.0 | 3.4 | 2.8 | 3.2 |
| loss, ml | | | | | | |
| Total loss, ml | 8.2 | 5.8 | 6.6 | 7.0 | 5.6 | 4.8 |

Notes:
*Base mud composition: 0.629 bbl ISO-TEQ ®, 12 lb OMNI-MUL ®, 0.15 bbl water, 8 lb/bbl CARBO-GEL ®, 18 lb calcium chloride, 239 lb/bbl MIL-BAR ®
**LCM additives ground by Retsch apparatus

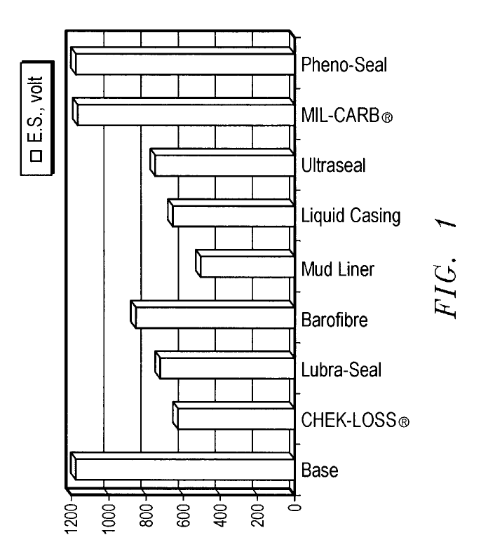

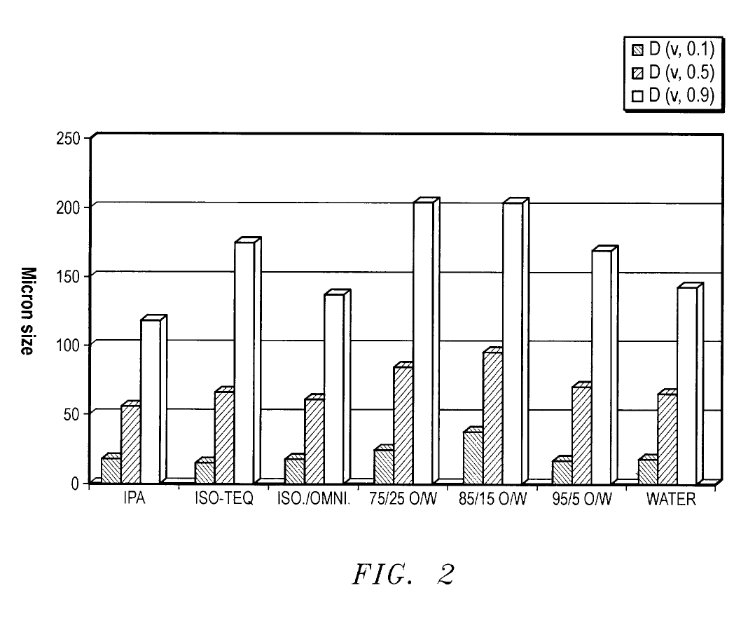

From the foregoing, it was concluded that the intrinsic affinity of cellulosic fibers for water was the cause of the influence of these fibers on electrical stability. Decreased electrical stability values were attributable to swollen, hydrated fibers coming into contact with the electrical stability meter probe. The magnitude of the phenomenon was related to the amount of available water—i.e. the more water, the lower the value. Therefore, the reduction in electrical stability increased as oil/water ratios decreased. Water wetting of solids was never observed in the test fluids. The bar chart of FIG. 1 summarizes the variety of LCM effects upon electrical stability. Particulate LCMs such as MIL-CARB® had no effect. Mud property data is presented in the foregoing Tables, and in FIG. 2.

The following are oil mud evaluations detailing routine analytical results of submitted field mud samples used in the test matrices.

TABLE 7

| Sample: | A |
|---|---|
| Sample Used For: | Drilling |
| Mud System: | Syn-Teq |
| Depth taken, feet: | 14800 |

| | | | |
|---|---|---|---|
| External Phase-Oil: | Iso- | S G, Weight Material: | 4.2 |
| | Teq | | |
| Mud Weight, lbm/gal: | 17.1 | Density of Oil, | 6.6 |
| | | lbm/gal: | |
| Specific Gravity | 2.05 | Excess Lime, lbm/bbl | 1.04 |
| of Mud: | | | |
| Rheologies @, ° F.: | 150 | Total Calcium, mg/L | 12000 |
| | | mud | |
| 600 rpm: | 98 | Total Chlorides, mg/L | 26000 |
| | | mud | |
| 300 rpm: | 58 | CaCl2, mg/L mud | 40820 |
| 200 rpm: | 44 | CaCl2, lbm/bbl of | 14.29 |
| | | mud | |
| 100 rpm: | 28 | CaCl2, mg/L | 402,797 |
| 6 rpm: | 8 | CaCl2, % by weight | 31.2 |
| 3 rpm: | 7 | Brine Density, g/ml | 1.29 |
| Plastic Viscosity, | 40 | Corrected Brine, % | 10.1 |
| cPs: | | by vol. | |
| Yield Point, lbf/ | 18 | Corrected Solids, % | 38.9 |
| 100 ft²: | | by vol. | |
| Initial Gel, lbf/ | 9 | Average Solids | 3.90 |
| 100 ft²: | | Density, | |
| | | g/ml | |
| 10 min Gel, lbf/ | 12 | Weight Material, % | 31.3 |
| 100 ft²: | | by vol. | |
| 30 min Gel, lbf/ | 13 | Weight Material, | 460.0 |
| 100 ft²: | | lbm/bbl | |
| API, mls/30 mins: | | Low Gravity Solids, % | 7.6 |
| | | by vol. | |
| HT-HP Temp, ° F.: | 300 | Low Gravity Solids, | 70.3 |
| | | lbm/bbl | |
| HT-HP, mls/30 mins: | 2.2 | Oil:Water Ratio = | 15.0 |
| | | Water | |
| Pom, mls/1 ml mud: | 0.8 | Oil:Water Ratio = | 85.0 |
| | | Oil | |
| AgN03, mls/1 ml mud: | 2.6 | Corrected Water | 16.6 |
| | | Ratio | |
| EDTA, mls/1 ml mud: | 3 | Corrected Oil | 83.4 |
| | | Ratio | |
| ES, volts: | 1200 | | |
| Solids, % by vol.: | 40 | | |
| Water, % by vol.: | 9 | | |
| Oil, % by vol.: | 51 | | |

TABLE 8

| | |
|---|---|
| Sample: | E |
| Sample Used For: | Drilling |
| Mud System: | ECOFLOW 200 |
| Depth taken, feet: | |

| | | | |
|---|---|---|---|
| External Phase-Oil: | Eco- | S G, Weight Material: | 4.2 |
| | flow | | |
| Mud Weight, lbm/gal: | 16.6 | Density of Oil, | 6.6 |
| | | lbm/gal: | |
| Specific Gravity | 2.00 | Excess Lime, lbm/bbl | 3.51 |
| of Mud: | | | |
| Rheologies @, ° F.: | 150 | Total Calcium, | 11200 |
| | | mg/L mud | |
| 600 rpm: | 82 | Total Chlorides, | 24000 |
| | | mg/L mud | |
| 300 rpm: | 47 | CaCl2, mg/L mud | 37680 |
| 200 rpm: | 35 | CaCl2, lbm/bbl | 13.19 |
| | | of mud | |
| 100 rpm: | 22 | CaCl2, mg/L | 530,455 |
| 6 rpm: | 6 | CaCl2, % by weight | 38.6 |
| 3 rpm: | 5 | Brine Density, g/ml | 1.38 |
| Plastic Viscosity, | 35 | Corrected Brine, % | 7.1 |
| cPs: | | by vol. | |
| Yield Point, lbf/ | 12 | Corrected Solids, % | 39.9 |
| 100 ft²: | | by vol. | |
| Initial Gel, lbf/ | 7 | Average Solids | 3.71 |
| 100 ft²: | | Density, g/ml | |
| 10 min Gel, lbf/ | 11 | Weight Material, % | 27.2 |
| 100 ft²: | | by vol. | |
| 30 min Gel, lbf/ | 11 | Weight Material, | 399.4 |
| 100 ft²: | | lbm/bbl | |
| API, mls/30 mins: | | Low Gravity Solids, % | 12.7 |
| | | by vol. | |
| HT-HP Temp, ° F.: | | Low Gravity Solids, | 118.1 |
| | | lbm/bbl | |
| HT-HP, mls/30 mins: | | Oil:Water Ratio = | 10.2 |
| | | Water | |
| Pom, mls/1 ml mud: | 2.7 | Oil:Water Ratio = | 89.8 |
| | | Oil | |
| AgN03, mls/1 ml | 2.4 | Corrected Water | 11.8 |
| mud: | | Ratio | |
| EDTA, mls/1 ml mud: | 2.8 | Corrected Oil | 88.2 |
| | | Ratio | |
| ES, volts: | 1360 | | |
| Solids, % by vol.: | 41 | | |
| Water, % by vol.: | 6 | | |
| Oil, % by vol.: | 53 | | |

TABLE 9

| | |
|---|---|
| Sample Number: | E |
| Sample Used For: | Drilling |
| Mud System: | Syn-Teq |
| Depth taken, feet: | |

| | | | |
|---|---|---|---|
| External Phase-Oil: | Eco- | S G, Weight Material: | 4.2 |
| | Flow 200 | | |
| Mud Weight, lbm/gal: | 17.0 | Density of Oil, | 6.5 |
| | | lbm/gal: | |
| Specific Gravity | 2.04 | Excess Lime, | 5.46 |
| of Mud: | | lbm/bbl | |
| Rheologies @, ° F.: | 150 | Total Calcium, | 14800 |
| | | mg/L mud | |
| 600 rpm: | 89 | Total Chlorides, | 30000 |
| | | mg/L mud | |
| 300 rpm: | 52 | CaCl2, mg/L mud | 47100 |
| 200 rpm: | 38 | CaCl2, lbm/bbl | 16.48 |
| | | of mud | |
| 100 rpm: | 25 | CaCl2, mg/L | 530,455 |
| 6 rpm: | 7 | CaCl2, % by weight | 38.6 |
| 3 rpm: | 6 | Brine Density, | 1.38 |
| | | g/ml | |
| Plastic Viscosity, | 37 | Corrected Brine, % | 8.9 |
| cPs: | | by vol. | |
| Yield Point, lbf/ | 15 | Corrected Solids, % | 38.1 |
| 100 ft²: | | by vol. | |
| Initial Gel, lbf/ | 8 | Average Solids | 3.94 |
| 100 ft²: | | Density, g/ml | |
| 10 min Gel, lbf/ | 12 | Weight Material, % | 31.7 |
| 100 ft²: | | by vol. | |
| 30 min Gel, lbf/ | 13 | Weight Material, | 466.6 |
| 100 ft²: | | lbm/bbl | |
| API, mls/30 mins: | | Low Gravity Solids, % | 6.4 |
| | | by vol. | |
| HT-HP Temp, ° F.: | 300 | Low Gravity Solids, | 59.1 |
| | | lbm/bbl | |
| HT-HP, mls/30 mins: | 2 | Oil:Water Ratio = | 12.4 |
| | | Water | |
| Pom, mls/1 ml mud: | 4.2 | Oil:Water Ratio = | 87.6 |
| | | Oil | |
| AgN03, mls/1 ml mud: | 3 | Corrected Water | 14.3 |
| | | Ratio | |
| EDTA, mls/1 ml mud: | 3.7 | Corrected Oil | 85.7 |
| | | Ratio | |
| ES, volts: | 1420 | | |
| Solids, % by vol.: | 39.5 | | |
| Water, % by vol.: | 7.5 | | |
| Oil, % by vol.: | 53 | | |

### EXAMPLE 2

The following LCM's were obtained from Grinding & Sizing Co. labeled as: “Wood Fiber” (pine), “Grape Pumice”, “Pith”, “Furfural” and “Total Control” (ground rubber). Ground coconut shell was obtained from Reade Co. in 325 mesh size and 80-325 mesh size ( “Reade 325F” and “Reade 325/80,” respectively).

Equipment

1. Prince Castle mixer

2. Fann viscometer, Model 35A

3. Thermometer, dial, 0-220° F.

4. Balance with precision of 0.01 g

5. Sieves (conforming to ASTM E11 requirements)

6. Roller oven, 150-250±5° F. (66-121±3° C.)

7. Spatula

8. Timer: interval, mechanical or electrical, precision of 0.1 minute

9. Jars (approximately 500 ml capacity) with sealing lids

10. Heating cup, OFI, 115 volt

11. Particle Plugging Apparatus

12. Aloxite disks

13. Malvern Mastersizer

PROCEDURES

The following INTEQ Fluids Laboratory procedures were used

Recommended Practice Standard Procedure for Field Testing Oil-Based Drilling Fluids, API Recommended Practice 13B-2, Third Edition, February 1998

Recommended Practice Standard Procedure for Field Testing Water-Based Drilling Fluids, API Recommended Practice 13B-1, Second Edition, September 1997

Instrumentation Manual for Malvern Mastersizer

The following results were observed:

TABLE 10
Evaluation of Various Fibrous LCM Additives from Grinding
& Sizing Co., Inc., as compared to CHEK-LOSS

| Materials: | | | | | | | |
|---|---|---|---|---|---|---|---|
| Field Mud FSR No. 4502, bbl | 1.0 | 1.0 | 1.0 | 1.0 | 1.0 | 1.0 | 1.0 |
| CHEK-LOSS, lb | — | 10 | — | — | — | — | — |
| Wood Fiber, lb | — | — | 10 | — | — | — | — |
| Grape Pumice, lb | — | — | — | 10 | — | — | — |
| Pith, lb | — | — | — | — | 10 | — | — |
| Furfural, lb | — | — | — | — | — | 10 | — |
| Total Control, lb | — | — | — | — | — | — | 10 |
| Stirred 15 min; rolled 16 hr, 150° F. | | | | | | | |
| Properties: | | | | | | | |
| 600 rpm rdg at 120° F. | 91 | 119 | 114 | 100 | 108 | 108 | 107 |
| 300 rpm rdg | 52 | 69 | 66 | 60 | 64 | 64 | 63 |
| 200 rpm rdg | 38 | 51 | 48 | 44 | 47 | 47 | 46 |
| 100 rpm rdg | 24 | 31 | 30 | 28 | 30 | 30 | 28 |
| 6 rpm rdg | 7 | 8 | 8 | 8 | 8 | 8 | 8 |
| 3 rpm rdg | 5 | 6 | 6 | 6 | 6 | 6 | 6 |
| Plastic viscosity, cp | 39 | 50 | 48 | 40 | 44 | 44 | 44 |
| Yield point, lb/100 sq ft | 13 | 19 | 18 | 20 | 20 | 20 | 19 |
| 10-sec gel, lb/100 sq ft | 8 | 9 | 9 | 9 | 9 | 9 | 9 |
| 10-min gel, lb/100 sq ft | 11 | 12 | 12 | 12 | 12 | 12 | 12 |
| Electrical stability, volt | 750 | 300 | 350 | 670 | 540 | 490 | 590 |
| Pom, mls/1 ml mud | 1.6 | 1.55 | — | 1.55 | — | — | — |
| Particle plugging apparatus results, | | | | | | | |
| (300° F., 1000 psi, 90-micron) | | | | | | | |
| Spurt loss, ml | 3.0 | 4.8 | — | 2.0 | — | — | — |
| Final total loss, ml | 5.0 | 7.2 | — | 2.8 | — | — | — |

Oil-Mud Sample Evaluation Report (FSR No. 4502)

| | | | |
|---|---|---|---|
| External Phase- | Eco- | S G, Weight Material: | 4.2 |
| Oil: | flow | | |
| Mud Weight, | 15.3 | Density of Oil, lbm/gal: | 6.6 |
| lbm/gal: | | | |
| Specific Gravity | 1.84 | Excess Lime, lbm/bbl | 1.95 |
| of Mud: | | | |
| Rheological | 150 | Total Calcium, mg/L mud | 10400 |
| Properties, ° F.: | | | |
| 600 rpm: | 60 | Total Chlorides, | 22000 |
| | | mg/L mud | |
| 300 rpm: | 35 | CaCl2, mg/L mud | 34540 |
| 200 rpm: | 26 | CaCl2, lbm/bbl of mud | 12.09 |
| 100 rpm: | 17 | CaCl2, mg/L | 347,539 |
| 6 rpm: | 5 | CaCl2, % by weight | 27.7 |
| 3 rpm: | 4 | Brine Density, g/ml | 1.25 |
| Plastic | 25 | Corrected Brine, % | 9.9 |
| Viscosity, | | by vol. | |
| cPs: | | | |
| Yield Point, | 10 | Corrected Solids, % | 35.1 |
| lbf/100 ft²: | | by vol. | |
| Initial Gel, | 7 | Average Solids | 3.65 |
| lbf/100 ft²: | | Density, g/ml | |
| 10 min Gel, | 10 | Weight Material, % | 22.6 |
| lbf/100 ft²: | | by vol. | |
| 30 min Gel, | 10 | Weight Material, | 331.5 |
| lbf/100 ft²: | | lbm/bbl | |
| API, mls/30 mins: | | Low Gravity Solids, % | 12.5 |
| | | by vol. | |
| HT-HP Temp, ° F.: | | Low Gravity Solids, | 116.0 |
| | | lbm/bbl | |
| HT-HP, mls/30 | | Oil:Water Ratio = | 14.1 |
| mins: | | Water | |
| Pom, mls/1 | 1.5 | Oil:Water Ratio = | 85.9 |
| ml mud: | | Oil | |
| AgN03, mls/1 | 2.2 | Corrected Water Ratio | 15.3 |
| ml mud: | | | |
| EDTA, mls/1 | 2.6 | Corrected Oil Ratio | 84.7 |
| ml mud: | | | |
| ES, volts: | 700 | | |
| Solids, % by | 36 | | |
| vol.: | | | |
| Water, % by vol.: | 9 | | |
| Oil, % by vol.: | 55 | | |

TABLE 11
Evaluation of Grinding & Sizing Co. Grape Pumice, as compared
to CHEK-LOSS, in a Solids-Laden Oil-Based Field Mud

| Materials: | | | |
|---|---|---|---|
| Field Mud (FSR No. 4522), bbl | 1.0 | 1.0 | 1.0 |
| CHEK-LOSS, lb | — | 10 | — |
| Grape Pumice, lb | — | — | 10 |
| Stirred 15 min; rolled 16 hr, 150° F. | | | |
| Properties: | | | |
| 600 rpm rdg at 120° F. | 150 | 190 | 150 |
| 300 rpm rdg | 81 | 104 | 80 |
| 200 rpm rdg | 58 | 72 | 56 |
| 100 rpm rdg | 32 | 42 | 31 |
| 6 rpm rdg | 5 | 7 | 5 |
| 3 rpm rdg | 4 | 5 | 4 |
| Plastic viscosity, cp | 69 | 86 | 70 |
| Yield point, lb/100 sq ft | 12 | 18 | 10 |
| 10-sec gel, lb/100 sq ft | 7 | 8 | 7 |
| 10-min gel, lb/100 sq ft | 23 | 27 | 24 |
| Electrical stability, volt | 620 | 350 | 585 |
| Pom, mls/1 ml mud | 1.0 | 1.0 | 1.0 |
| Particle plugging apparatus results, | | | |
| (300° F., 1000 psi, 90-micron) | | | |
| Spurt loss, ml | 4.6 | 5.2 | 2.8 |
| Final total loss, ml | 9.0 | 9.6 | 5.2 |

TABLE 12
Evaluation of Reade Co. Ground Coconut Shell, as compared
to CHEK-LOSS, in a Solids-Laden Oil-Based Field Mud

Materials:

| | | | | |
|---|---|---|---|---|
| Field Mud (FSR No. 4522), bbl | 1.0 | 1.0 | 1.0 | 1.0 |
| CHEK-LOSS, lb | — | 10 | — | — |
| Reade 325F, lb | — | — | 10 | — |
| Reade 80/325, lb | — | — | — | 10 |
| Stirred 15 min; rolled 16 hr, 150° F. | | | | |

Properties:

| | | | | |
|---|---|---|---|---|
| 600 rpm rdg at 120° F. | 150 | 190 | 173 | 185 |
| 300 rpm rdg | 81 | 104 | 97 | 102 |
| 200 rpm rdg | 58 | 72 | 72 | 75 |
| 100 rpm rdg | 32 | 42 | 41 | 42 |
| 6 rpm rdg | 5 | 7 | 8 | 6 |
| 3 rpm rdg | 4 | 5 | 6 | 4 |
| Plastic viscosity, cp | 69 | 86 | 76 | 83 |
| Yield point, lb/100 sq ft | 12 | 18 | 21 | 19 |
| 10-sec gel, lb/100 sq ft | 7 | 8 | 11 | 11 |
| 10-min gel, lb/100 sq ft | 23 | 27 | 48 | 40 |
| Electrical stability, volt | 620 | 350 | 605 | 585 |
| Pom, mls/1 ml mud | 1.0 | 1.0 | — | 0.95 |
| Particle plugging apparatus results, | | | | |
| (300° F., 1000 psi, 90-micron) | | | | |
| Spurt loss, ml | 4.6 | 5.2 | — | 3.4 |
| Final total loss, ml | 9.0 | 9.6 | — | 6.6 |

The coconut materials had very minimal impact upon the electrical stability value of the base fluid. However, these materials appeared to be kilned, thus making them more characteristic as a particulate rather than a fiber. Resultant rheological properties were not satisfactory.

In Data Tables 11 and 12, Formula 4522 was the following:

Oil-Mud Sample Evaluation Report (FSR No. 4522)

| | | | |
|---|---|---|---|
| External Phase-Oil: | Diesel | S G, Weight Material: | 4.2 |
| Mud Weight, lbm/gal: | 16.5 | Density of Oil, lbm/gal: | 7.1 |
| Specific Gravity of Mud: | 1.98 | Excess Lime, lbm/bbl | 1.30 |
| Rheological Properties, ° F.: | 150, 120 | Total Calcium, mg/L mud | 5200 |
| 600 rpm: | 96, 137 | Total Chlorides, mg/L mud | 9000 |
| 300 rpm: | 52, 75 | CaCl2, mg/L mud | 14130 |
| 200 rpm: | 36, 52 | CaCl2, lbm/bbl of mud | 4.95 |
| 100 rpm: | 21, 29 | CaCl2, mg/L | 150,804 |
| 6 rpm: | 4, 5 | CaCl2, % by weight | 13.6 |
| 3 rpm: | 3, 4 | Brine Density, g/ml | 1.11 |
| Plastic Viscosity, cPs: | 44, 62 | Corrected Brine, % by vol. | 9.4 |
| Yield Point, lbf/100 ft²: | 8, 13 | Corrected Solids, % by vol. | 39.1 |
| Initial Gel, lbf/100 ft²: | 5, 6 | Average Solids Density, g/ml | 3.67 |
| 10 min Gel, lbf/100 ft²: | 21, 22 | Weight Material, % by vol. | 25.7 |
| 30 min Gel, lbf/100 ft²: | 29, 30 | Weight Material, lbm/bbl | 377.4 |
| API, mls/30 mins: | | Low Gravity Solids, % by vol. | 13.5 |
| HT-HP Temp, ° F.: | 300 | Low Gravity Solids, lbm/bbl | 124.8 |
| HT-HP, mls/30 mins: | 9.2 | Oil:Water Ratio = Water | 14.9 |
| Pom, mls/1 ml mud: | 1 | Oil:Water Ratio = Oil | 85.1 |
| AgN03, mls/1 ml mud: | 0.9 | Corrected Water Ratio | 15.4 |
| EDTA, mls/1 ml mud: | 1.3 | Corrected Oil Ratio | 84.6 |
| ES, volts: | 650 | | |
| Solids, % by vol.: | 39.5 | | |
| Water, % by vol.: | 9 | | |
| Oil, % by vol.: | 51.5 | | |

TABLE 13
Evaluation of Grinding & Sizing Co. Grape Pumice, as compared
to CHEK-LOSS, in a Laboratory-Prepared Water-Based Mud

| Materials: | | | |
|---|---|---|---|
| Lab-Prepared Mud (FSR No. | 1.0 | 1.0 | 1.0 |
| 4423b), bbl | | | |
| CHEK-LOSS, lb | — | 10 | — |
| Grape Pumice, lb | — | — | 10 |
| Stirred 15 min; rolled 16 hr, 150° F. | | | |
| Properties: | | | |
| 600 rpm rdg at 120° F. | 74 | 141 | 90 |
| 300 rpm rdg | 40 | 80 | 52 |
| 200 rpm rdg | 28 | 57 | 40 |
| 100 rpm rdg | 17 | 35 | 25 |
| 6 rpm rdg | 3 | 9 | 8 |
| 3 rpm rdg | 2 | 7 | 6 |
| Plastic viscosity, cp | 24 | 61 | 38 |
| Yield point, lb/100 sq ft | 16 | 19 | 14 |
| 10-sec gel, lb/100 sq ft | 6 | 14 | 14 |
| 10-min gel, lb/100 sq ft | 23 | 38 | 44 |
| pH | 9.0 | 8.4 | 7.5 |
| API filtrate, ml | 0.6 | 0.4 | 0.4 |

In Data Table 13, Formulation 4423b was the following:

| Formulation (FSR 4423b) | |
|---|---|
| Water, bbl | 0.6 |
| MILGEL, lb | 4.0 |
| Soda Ash, lb | 1.0 |
| NEW-DRILL LV, lb | 0.5 |
| Sea salt, lb | 8.8 |
| MIL-PAC LV, lb | 1.0 |
| CHEMTROL X, lb | 6.0 |
| LIGCO, lb | 6.0 |
| TEQ-THIN, lb | 3.0 |
| SULFATROL, lb | 2.0 |
| Caustic Soda, lb | 2.5 |
| AQUA-MAGIC, % vol | 3.0 |
| ALL-TEMP, lb | 1.0 |
| Rev Dust, lb | 18.0 |
| MIL-BAR, lb | 450.0 |
| MIL-CARB, lb | 10.0 |
| CHECK-LOSS, lb | 3.0 |

Grape Pumice appears to fulfill the needed characteristic of being composed of more lignin rather than cellulose. Grape Pumice caused significantly less impact (5-10% decreases) upon electrical stability values, as compared to 50-60% decreases when adding CHEK-LOSS. Grape Pumice also induced less impact upon the plastic viscosities of the oil muds, as compared to CHEK-LOSS. Grape Pumice provided better PPA (particle plugging apparatus) results, as compared to CHEK-LOSS at test conditions of 300° F., 1000 psi differential, 90-micron aloxite disk.

### EXAMPLE 3

The papermaking industry uses a measurement called the Water Retention Value (WRV), which gives the amount of water intimately associated with a given dry weight of wood pulp. This represents the capacity of fibers to swell in the presence of water. This value varies with the source of plant fibers (corn, peanut, walnut, almond, coconut, etc.). The paper industry wants more cellulose, less lignin. The need in this application is to choose a plant fiber source with a ratio of more lignin with less cellulose. Lignin, which serves as the “skeletal” structure for plants, is significantly less water-absorbent.

The following described procedure is a modification of the TAPPI 1991 UM-256 procedure used in the papermaking industry. Equipment used included:

1. Prince Castle mixer

2. Tachometer

3. 500-ml glass jars with lids

4. Deionized water

5. Electronic balance

6. Vacuum pump

7. 2-liter Erlenmeyer flask

8. Buchner funnel

9. Whatman filter paper No. 41

An amount of 25 g test material was added to a glass jar. 250 ml of deionized water was then added. The slurry was sheared at 3000 rpm for 5 min. The glass jar was capped and rolled 16 hr at 150° F. After cooling, the jar contents was poured into an assembled Buchner funnel (using Whatman filter paper No. 41) fitted on a 2-liter Erlenmeyer flask, hooked to a vacuum pump. Filtration was conducted for two hours maximum. The Buchner funnel with test material content was removed from the flask and was weighed. Calculation of the WRV would be as follows:

(Buchner funnel with filter paper and retained wet test material minus Buchner funnel with wet paper) minus initial 25 g dry test material. Resultant value then divided by initial 25 g dry test material.

Results were, as follows:

| | | Weight of | |
|---|---|---|---|
| | Weight, | filtered, wet | |
| Test Material | g | Material, g | WRV |
| Buchner funnel with wet | 602.2 | — | — |
| paper | | | |
| Above with MIL-CARB | 630.8 | 28.6 | 0.144 |
| Above with Grape Pumice | 633.6 | 31.4 | 0.256 |
| Above with CHEK-LOSS | 727.8 | 125.6 | 4.024 |
| Above with Mud-Liner | 745.0 | 142.8 | 4.712 |
| Above with Liquid Casing | 715.0 | 112.8 | 3.512 |

The Grape Pumice material appears to fulfill the needed characteristic of being composed of more lignin rather than cellulose.

Particle size analyses by Malvern Mastersizer instrumentation showed the Grape Pumice to be near-similar to CHEK-LOSS:

| Test Material | D (v, 0.1) | D (v, 0.5) | D (v, 0.9) |
|---|---|---|---|
| Grape Pumice | 16 μm | 69 μm | 166 μm |
| CHEK-LOSS | 21 μm | 68 μm | 185 μm |

As evident by this data, particle size distribution would not contribute to differentiating WRV between the two materials; Grape Pumice exhibits significantly less water absorbency, a characteristic favorable for application as a LCM in invert emulsion drilling fluids while not interfering with emulsion stability measurements.

### EXAMPLE 4

The Grape Pumice material, being acidic, will lower pH levels in aqueous muds. A test was conducted by adding 10 lb Grape Pumice to a 1-bbl equivalent of deionized water. Resultant pH was 3.5. Blending 10 lb Grape Pumice with 0.2 lb soda ash kept the pH at 7.0.

Because of this concern, alkalinity levels were measured in the oil muds tested with Grape Pumice. There were no changes, thus the Grape Pumice seems to be preferentially oil-wetted.

Persons of ordinary skill in the art will recognize that many modifications may be made to the present invention without departing from the spirit and scope of the invention. The embodiment described herein is meant to be illustrative only and should not be taken as limiting the invention, which is defined in the claims.

We claim:

1. A method for maintaining electrical stability in an emulsion type drilling, drill-in, or completion fluid comprising lost circulation material (LCM), said method comprising:
providing an initial fluid selected from the group consisting of an emulsion-type drilling, drill-in, or completion fluid, said initial fluid having effective rheology and fluid loss control properties;
using a fibrous LCM in said initial fluid, said fibrous LCM consisting essentially of a quantity of high lignin lost circulation material (HLLCM), said fibrous HLLCM being effective to produce a treated fluid having effective rheology and fluid loss control properties;
wherein said initial fluid exhibits a first electrical stability value and said treated fluid exhibits a second electrical stability value that is a maximum of 20% less than said first electrical stability value.

2. The method of claim 1 wherein said second electrical stability value is a maximum of 18% less than said first electrical stability value.

3. The method of claim 1 wherein second electrical stability value is a maximum of 15% less than said first electrical stability value.

4. The method of claim 1 wherein said second electrical stability value is a maximum of 12% less than said first electrical stability value.

5. The method of claim 1 wherein said fibrous HLLCM has a water retention value of about 1 or less.

6. The method of claim 1 wherein said fibrous HLLCM has a water retention value of about 0.5 or less.

7. The method of claim 1 wherein said fibrous HLLCM has a water retention value of about 0.3 or less.

8. The method of claim 2 wherein said fibrous HLLCM has a water retention value of about 1 or less.

9. The method of claim 2 wherein said fibrous HLLCM has a water retention value of about 0.5 or less.

10. The method of claim 2 wherein said fibrous HLLCM has a water retention value of about 0.3 or less.

11. A method for maintaining electrical stability in an emulsion type drilling, drill-in, or completion fluid comprising lost circulation material (LCM), said method comprising:
providing an initial fluid selected from the group consisting of an invert emulsion drilling, drill-in, or completion fluid, said initial fluid having effective rheology and fluid loss control properties;
using a fibrous LCM in said initial fluid, said fibrous LCM consisting essentially of a quantity of high lignin lost circulation material (HLLCM), said fibrous HLLCM being effective to produce a treated fluid having effective rheology and fluid loss control properties;
wherein said initial fluid exhibits a first electrical stability value and said treated fluid exhibits a second electrical stability value that is a maximum of 20% less than said first electrical stability value.

12. The method of claim 11 wherein said second electrical stability value is a maximum of 18% less than said first electrical stability value.

13. The method of claim 11 wherein said second electrical stability value is a maximum of 15% less than said first electrical stability value.

14. The method of claim 11 wherein said second electrical stability value is a maximum of 12% less than said first electrical stability value.

15. The method of claim 11 wherein said fibrous HLLCM has a water retention value of about 1 or less.

16. The method of claim 11 wherein said fibrous HLLCM has a water retention value of about 0.5 or less.

17. The method of claim 11 wherein said fibrous HLLCM has a water retention value of about 0.3 or less.

18. The method of claim 12 wherein said fibrous HLLCM has a water retention value of about 1 or less.

19. The method of claim 12 wherein said fibrous HLLCM has a water retention value of about 0.5 or less.

20. The method of claim 12 wherein said fibrous HLLCM has a water retention value of about 0.3 or less.

21. The method of claim 11 wherein said HLLCM is selected from the group consisting of grape pumice, bulrush plants, and lignin byproducts from processing plant material into paper.

22. A method for maintaining electrical stability in a drilling, drill-in, or completion fluid, said method comprising:
providing an initial fluid selected from the group consisting of an emulsion type drilling, drill-in, or completion fluid having effective rheology and fluid loss control properties; and
using as LCM in said initial fluid a fibrous HLLCM having a water retention value of about 1 or less, said HLLCM being effective to produce a treated fluid having effective rheology and fluid loss control properties.

23. The method of claim 22 wherein said fibrous HLLCM has a water retention value of about 0.5 or less.

24. The method of claim 22 wherein said fibrous HLLCM has a water retention value of about 0.3 or less.

25. A method for maintaining electrical stability in a drilling, drill-in, or completion fluid, said method comprising:
providing an initial fluid selected from the group consisting of invert emulsion drilling, drill-in, or completion fluids having effective rheology and fluid loss control properties; and
using as LCM in said initial fluid a fibrous HLLCM having a water retention value of about 1 or less, said fibrous HLLCM being effective to produce a treated fluid having effective rheology and fluid loss control properties.

26. The method of claim 25 wherein said LCM has a water retention value of about 0.5 or less.

27. The method of claim 25 wherein said LCM has a water retention value of about 0.3 or less.

28. A method for maintaining electrical stability in a drilling, drill-in, or completion fluid, said method comprising:
providing an initial fluid selected from the group consisting of a emulsion type drilling, drill-in, or completion fluid, said initial fluid having effective rheology and fluid loss control properties; and
using an LCM in said initial fluid, said LCM consisting essentially of grape pumice effective to produce a treated fluid having effective rheology and fluid loss control properties.

29. A method for maintaining electrical stability in a drilling, drill-in, or completion fluid, said method comprising:
providing an initial fluid selected from the group consisting of an invert emulsion drilling, drill-in, or completion fluid, said initial fluid having effective rheology and fluid loss control properties; and
using an LCM in said initial fluid, said LCM consisting essentially of grape pumice effective to produce a treated fluid having effective rheology and fluid loss control properties.

30. A treated emulsion type fluid selected from the group consisting of a drilling, drill-in, or completion fluid, said emulsion type drilling fluid having effective rheology and fluid loss control properties and comprising a lost circulation material consisting essentially of an HLLCM, said wherein said emulsion type fluid exhibits a first electrical stability value and said treated emulsion type fluid exhibits a second electrical stability value that is a maximum of 20% less than said first electrical stability value.

31. The treated emulsion type fluid of claim 30 wherein said second electrical stability value is a maximum of 18% less than said first electrical stability value.

32. The treated emulsion type fluid of claim 30 wherein second electrical stability value is a maximum of 15% less than said first electrical stability value.

33. The treated emulsion type fluid of claim 30 wherein said second electrical stability value is a maximum of 12% less than said first electrical stability value.

34. The treated emulsion type fluid of claim 30 wherein said HLLCM has a water retention value of about 1 or less.

35. The treated emulsion type fluid of claim 30 wherein said HLLCM has a water retention value of about 0.5 or less.

36. The treated emulsion type fluid of claim 30 wherein said HLLCM has a water retention value of about 0.3 or less.

37. The treated emulsion type fluid of claim 31 wherein said HLLCM has a water retention value of about 1 or less.

38. The treated emulsion type fluid of claim 31 wherein said HLLCM has a water retention value of about 0.5 or less.

39. The treated emulsion type fluid of claim 31 wherein said HLLCM has a water retention value of about 0.3 or less.

40. The treated emulsion type fluid of claim 30 wherein said HLLCM is selected from the group consisting of grape pumice, bulrush plants, and lignin byproducts from processing plant material into paper.

41. The treated emulsion type fluid of claim 30 wherein said HLLCM comprises a particle size distribution of from about 10 μm to about 200 μm.

42. A treated invert emulsion fluid selected from the group consisting of a drilling, drill-in, or completion fluid, said invert emulsion fluid having effective rheology and fluid loss control properties and comprising a lost circulation material consisting essentially of an HLLCM, said wherein said invert emulsion fluid exhibits a first electrical stability value and said treated emulsion type fluid exhibits a second electrical stability value that is a maximum of 20% less than said first electrical stability value.

43. The treated emulsion type fluid of claim 42 wherein said second electrical stability value is a maximum of 18% less than said first electrical stability value.

44. The treated emulsion type fluid of claim 42 wherein second electrical stability value is a maximum of 15% less than said first electrical stability value.

45. The treated emulsion type fluid of claim 42 wherein said second electrical stability value is a maximum of 12% less than said first electrical stability value.

46. The treated emulsion type fluid of claim 42 wherein said HLLCM has a water retention value of about 1 or less.

47. The treated emulsion type fluid of claim 42 wherein said HLLCM has a water retention value of about 0.5 or less.

48. The treated emulsion type fluid of claim 42 wherein said HLLCM has a water retention value of about 0.3 or less.

49. The treated emulsion type fluid of claim 43 wherein said HLLCM has a water retention value of about 1 or less.

50. The treated emulsion type fluid of claim 43 wherein said HLLCM has a water retention value of about 0.5 or less.

51. The treated emulsion type fluid of claim 43 wherein said HLLCM has a water retention value of about 0.3 or less.

52. The treated emulsion type fluid of claim 42 wherein said HLLCM comprises a particle size distribution of from about 10 μm to about 200 μm.

53. A treated emulsion type fluid selected from the group consisting of a drilling, drill-in, or completion fluid, said fluid having effective rheology and fluid loss control properties and consisting essentially of an LCM having a water retention value of about 1 or less.

54. The treated emulsion type fluid of claim 53 wherein said LCM has a water retention value of about 0.5 or less.

55. The treated emulsion type fluid of claim 54 wherein said LCM has a water retention value of about 0.3 or less.

56. The treated emulsion type fluid of claim 53 wherein said LCM comprises a particle size distribution of from about 10 μm to about 200 μm.

57. A treated invert emulsion fluid selected from the group consisting of a drilling, drill-in, or completion fluid, said fluid having effective rheology and fluid loss control properties and consisting essentially of an LCM having a water retention value of about 1 or less.

58. The treated emulsion type fluid of claim 57 wherein said LCM has a water retention value of about 0.5 or less.

59. The treated emulsion type fluid of claim 57 wherein said LCM has a water retention value of about 0.3 or less.

60. The treated emulsion type fluid of claim 57 wherein said LCM comprises a particle size distribution of from about 10 μm to about 200 μm.

61. A treated emulsion type fluid selected from the group consisting of a drilling, drill-in, or completion fluid, said fluid having effective rheology and fluid loss control properties and comprising a fibrous LCM, said fibrous LCM consisting essentially of materials selected from the group consisting of grape pumice, bulrush plants, and lignin byproducts from the processing of plant material into paper.

62. The treated emulsion type fluid of claim 61 wherein said LCM comprises a particle size distribution of from about 10 μm to about 200 μm.

63. A treated emulsion type fluid selected from the group consisting of a drilling, drill-in, or completion fluid, said fluid having effective rheology and fluid loss control properties and comprising a fibrous LCM consisting essentially of grape pumice.

64. The treated emulsion type fluid of claim 63 wherein said fibrous LCM comprises a particle size distribution of from about 10 μm to about 200 μm.

65. A treated invert emulsion fluid selected from the group consisting of a drilling, drill-in, or completion fluid, said fluid having effective rheology and fluid loss control properties and comprising a fibrous LCM consisting essentially of grape pumice.

66. The treated invert emulsion fluid of claim 65 wherein said fibrous LCM comprises a particle size distribution of from about 10 μm to about 200 μm.

67. A spotting pill comprising from about 1 to about 100 ppb of an HLLCM and a carrier liquid, wherein a given emulsion type fluid exhibits a first electrical stability value absent said spotting pill and said given emulsion type fluid comprising said spotting pill exhibits a second electrical stability value that is a maximum of 20% less than said first electrical stability value.

68. The spotting pill of claim 67 wherein said second electrical stability value is a maximum of 18% less than said first electrical stability value.

69. The spotting pill of claim 67 wherein second electrical stability value is a maximum of 15% less than said first electrical stability value.

70. The spotting pill of claim 67 wherein said second electrical stability value is a maximum of 12% less than said first electrical stability value.

71. The spotting pill of claim 67 wherein said HLLCM has a water retention value of about 1 or less.

72. The spotting pill of claim 67 wherein said HLLCM has a water retention value of about 0.5 or less.

73. The spotting pill of claim 67 wherein said HLLCM has a water retention value of about 0.3 or less.

74. The spotting pill of claim 68 wherein said HLLCM has a water retention value of about 1 or less.

75. The spotting pill of claim 68 wherein said HLLCM has a water retention value of about 0.5 or less.

76. The spotting pill of claim 68 wherein said HLLCM has a water retention value of about 0.3 or less.

77. The spotting pill of claim 67 wherein said HLLCM is selected from the group consisting of grape pumice, bulrush plants, and lignin byproducts from processing plant material into paper.

78. The spotting pill of claim 67 comprising from about 5 to about 50 ppb of said HLLCM.

79. The spotting pill of claim 67 wherein said carrier liquid is selected from the group consisting of polyalkylene oxides and copolymers thereof, polyalkyleneoxide glycol ethers, glycols, polyglycols, tripropylene glycol bottoms, and combinations thereof.

80. The spotting pill of claim 67 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

81. The spotting pill of claim 67 wherein said carrier liquid is selected from the group consisting of ethylene glycol, tripropylene glycol bottoms, and combinations thereof.

82. The spotting pill of claim 68 wherein said carrier liquid is selected from the group consisting of ethylene glycol, tripropylene glycol bottoms, and combinations thereof.

83. The spotting pill of claim 69 wherein said carrier liquid is selected from the group consisting of ethylene glycol, tripropylene glycol bottoms, and combinations thereof.

84. The spotting pill of claim 70 wherein said carrier liquid is selected from the group consisting of ethylene glycol, tripropylene glycol bottoms, and combinations thereof.

85. A spotting pill comprising from about 1 to about 100 ppb of an HLLCM and a carrier liquid, wherein a given invert emulsion fluid exhibits a first electrical stability value absent said spotting pill and said given invert emulsion fluid comprising said spotting pill exhibits a second electrical stability value that is a maximum of 20% less than said first electrical stability value.

86. The spotting pill of claim 85 wherein said second electrical stability value is a maximum of 18% less than said first electrical stability value.

87. The spotting pill of claim 85 wherein second electrical stability value is a maximum of 15% less than said first electrical stability value.

88. The spotting pill of claim 85 wherein said second electrical stability value is a maximum of 12% less than said first electrical stability value.

89. The spotting pill of claim 85 wherein said HLLCM has a water retention value of about 1 or less.

90. The spotting pill of claim 85 wherein said HLLCM has a water retention value of about 0.5 or less.

91. The spotting pill of claim 85 wherein said HLLCM has a water retention value of about 0.3 or less.

92. The spotting pill of claim 86 wherein said HLLCM has a water retention value of about 1 or less.

93. The spotting pill of claim 86 wherein said HLLCM has a water retention value of about 0.5 or less.

94. The spotting pill of claim 86 wherein said HLLCM has a water retention value of about 0.3 or less.

95. The spotting pill of claim 85 wherein said HLLCM is selected from the group consisting of grape pumice, bulrush plants, and lignin byproducts from processing plant material into paper.

96. The spotting pill of claim 85 comprising from about 5 to about 50 ppb of said HLLCM.

97. The spotting pill of claim 85 wherein said carrier liquid is selected from the group consisting of polyalkylene oxides and copolymers thereof, polyalkyleneoxide glycol ethers, glycols, polyglycols, tripropylene glycol bottoms, and combinations thereof.

98. The spotting pill of claim 85 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

99. The spotting pill of claim 85 wherein said carrier liquid is selected from the group consisting of ethylene glycol, tripropylene glycol bottoms, and combinations thereof.

100. The spotting pill of claim 86 wherein said carrier liquid is selected from the group consisting of ethylene glycol, tripropylene glycol bottoms, and combinations thereof.

101. The spotting pill of claim 87 wherein said carrier liquid is selected from the group consisting of ethylene glycol, tripropylene glycol bottoms, and combinations thereof.

102. The spotting pill of claim 88 wherein said carrier liquid is selected from the group consisting of ethylene glycol, tripropylene glycol bottoms, and combinations thereof.

103. A spotting pill comprising from about 1 to about 100 ppb of an HLLCM and a carrier liquid, wherein said HLLCM has a water retention value of about 1 or less.

104. The spotting pill of claim 103 comprising from about 5 to about 50 ppb of an HLLCM and a carrier liquid.

105. The treated emulsion type fluid of claim 103 wherein said HLLCM has a water retention value of about 0.5 or less.

106. The treated emulsion type fluid of claim 103 wherein said HLLCM has a water retention value of about 0.3 or less.

107. The treated emulsion type fluid of claim 103 wherein said LCM comprises a particle size distribution of from about 10 μm to about 200 μm.

108. The spotting pill of claim 103 wherein said carrier liquid is selected from the group consisting of polyalkylene oxides and copolymers thereof, polyalkyleneoxide glycol ethers, glycols, polyglycols, tripropylene glycol bottoms, and combinations thereof.

109. The spotting pill of claim 103 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

110. The spotting pill of claim 103 wherein said carrier liquid is selected from the group consisting of ethylene glycol, tripropylene glycol bottoms, and combinations thereof.

111. The spotting pill of claim 104 wherein said carrier liquid is selected from the group consisting of ethylene glycol, tripropylene glycol bottoms, and combinations thereof.

112. The spotting pill of claim 105 wherein said carrier liquid is selected from the group consisting of ethylene glycol, tripropylene glycol bottoms, and combinations thereof.

113. The spotting pill of claim 106 wherein said carrier liquid is selected from the group consisting of ethylene glycol, tripropylene glycol bottoms, and combinations thereof.

114. A spotting pill comprising from about 1 to about 100 ppb of an HLLCM and a carrier liquid, wherein said HLLCM consists essentially of materials selected from the group consisting of grape pumice, bulrush plants, and lignin byproducts from the processing of plant material into paper.

115. The spotting pill of claim 114 comprising from about 5 to about 50 ppb of said HLLCM.

116. The spotting pill of claim 114 wherein said LCM comprises a particle size distribution of from about 10 μm to about 200 μm.

117. The spotting pill of claim 114 wherein said carrier liquid is selected from the group consisting of polyalkylene oxides and copolymers thereof, polyalkyleneoxide glycol ethers, glycols, polyglycols, tripropylene glycol bottoms, and combinations thereof.

118. The spotting pill of claim 114 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

119. The spotting pill of claim 114 wherein said carrier liquid is selected from the group consisting of ethylene glycol, tripropylene glycol bottoms, and combinations thereof.

120. The spotting pill of claim 115 wherein said carrier liquid is selected from the group consisting of ethylene glycol, tripropylene glycol bottoms, and combinations thereof.

121. A spotting pill comprising from about 1 to about 100 ppb grape pumice and a carrier liquid.

122. The spotting pill of claim 121 comprising from about 5 to about 50 ppb of said grape pumice.

123. The spotting pill of claim 121 wherein said carrier liquid is selected from the group consisting of polyalkylene oxides and copolymers thereof, polyalkyleneoxide glycol ethers, glycols, polyglycols, tripropylene glycol bottoms, and combinations thereof.

124. The spotting pill of claim 122 wherein said carrier liquid is selected from the group consisting of polyalkylene oxides and copolymers thereof, polyalkyleneoxide glycol ethers, glycols, polyglycols, tripropylene glycol bottoms, and combinations thereof.

125. The spotting pill of claim 121 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

126. The spotting pill of claim 122 wherein said carrier liquid is selected from the group consisting of ethylene glycols, diethylene glycols, triethylene glycols, tetraethylene glycols, propylene glycols, dipropylene glycols, tripropylene glycols, tetrapropylene glycols, polyethylene oxides, polypropylene oxides, copolymers of polyethylene oxides and polypropylene oxides, polyethylene glycol ethers, polypropylene glycol ethers, polyethylene oxide glycol ethers, polypropylene oxide glycol ethers, and polyethylene oxide/polypropylene oxide glycol ethers.

127. The spotting pill of claim 121 wherein said carrier liquid is selected from the group consisting of ethylene glycol, tripropylene glycol bottoms, and combinations thereof.

128. The spotting pill of claim 122 wherein said carrier liquid is selected from the group consisting of ethylene glycol, tripropylene glycol bottoms, and combinations thereof.

129. A spotting pill comprising from about 1 to about 100 ppb of an HLLCM and a carrier liquid comprising tripropylene glycol bottoms.

130. The spotting pill of claim 129 comprising from about 5 to about 50 ppb of said HLLCM.

131. A spotting pill comprising from about 1 to about 100 ppb grape pumice and a carrier liquid comprising tripropylene glycol bottoms.

132. The spotting pill of claim 131 comprising from about 5 to about 50 ppb of said grape pumice.
